(19) United States
(12) Patent Application Publication
(10) Pub. No.: US 2026/0260275 A1
(43) Pub. Date: Sep. 3, 2026

(54) INFORMATION PROVIDING SYSTEM, INFORMATION PROVIDING METHOD, AND INFORMATION PROVIDING PROGRAM

(71) Applicant: KOTOBAZUKURI CO., LTD., Kawasaki-shi (JP)

(72) Inventors: Ken NYUKAI, Kawasaki-shi (JP); Yoshinori ICHIKAWA, Kawasaki-shi (JP); Tomohiro KOZANO, Kawasaki-shi (JP)

(73) Assignee: KOTOBAZUKURI CO., LTD., Kawasaki-shi (JP)

(21) Appl. No.: 19/126,246

(22) PCT Filed: Oct. 31, 2023
(86) PCT No.: PCT/JP2023/039170

§ 371 Date: May 12, 2026

(30) Foreign Application Priority Data
Nov. 1, 2022 (JP) 2022-175610

(51) Int. Cl. G06Q 30/0601; G06Q 50/02

(52) U.S. Cl. CPC G06Q 30/0624; G06Q 50/02

(57) ABSTRACT

An object is to suitably register and provide information regarding a commodity. An information providing system for providing information regarding a commodity including a produce, the information providing system including a production information registration unit, an analysis information registration unit, and a provision unit, in which the production information registration unit accepts and stores commodity information input via a commodity information registration screen in a producer terminal operated by a producer who produces a commodity, the analysis information registration unit accepts analysis information and stores the analysis information in association with the commodity information, the analysis information is information regarding analysis of a commodity performed in an analyzing facility and includes an analysis result regarding a growth environment of a commodity, and the provision unit accepts an information provision request transmitted from a viewer terminal operated by a viewer, and provides the commodity information and the analysis information to the viewer terminal.

### TECHNICAL FIELD

The present invention relates to an information providing system, an information providing method, and an information providing program.

### BACKGROUND ART

Conventionally, a technology has been known for providing consumers with detailed information such as a production place and components regarding food including agricultural products.

Patent Literature 1 discloses a system for preventing a decrease in reliability due to falsification of information regarding distribution of agricultural products. In the technology disclosed in Patent Literature 1, a hash value is calculated for each process for unique data in each process regarding distribution of agricultural products, such as a field process, a product process, and a sorting process, and a two-dimensional code is generated from the hash value in the last process. It is disclosed that, in a case where a consumer picks up an agricultural product, a production and distribution process of the agricultural product can be grasped by reading the attached two-dimensional code.

Patent Literature 2 discloses a system that makes it possible to easily check whether information displayed on a label or the like attached to food is reliable. It is disclosed that a purchaser who purchases the food can acquire a component analysis result corresponding to a certification code displayed as a barcode on a label.

### CITATION LIST

### Patent Literature

Patent Literature 1: WO 2020/044441 A

Patent Literature 2: WO 2007/049344 A

### SUMMARY OF INVENTION

### Technical Problem

However, in Patent Literature 1 and Patent Literature 2, there is a disclosure regarding provision of information regarding food, such as components and distribution processes, to consumers, but there is no disclosure regarding registration of an analysis result of food in an analyzing facility including a component analyzing center and a method of registering information regarding food by a producer. Therefore, a target food physically moves in the process of analysis and distribution, but information regarding the food cannot be suitably registered.

The present invention has been made in view of the above problems, and an object thereof is to provide an information providing system, an information providing method, and an information providing program that suitably provide information regarding a commodity registered by a producer and an analyzing facility.

### Solution to Problem

In order to solve the above-described problem, the present invention is an information providing system for providing information regarding a commodity including a produce, the information providing system including a production information registration unit, an analysis information registration unit, and a provision unit, in which the production information registration unit accepts and stores commodity information input via a commodity information registration screen in a producer terminal operated by a producer who produces a commodity, the analysis information registration unit accepts analysis information and stores the analysis information in association with the commodity information, the analysis information is information regarding analysis of a commodity and includes an analysis result regarding a growth environment of a commodity, and the provision unit accepts an information provision request transmitted from a viewer terminal operated by a viewer, and provides the commodity information and the analysis information to the viewer terminal.

With such a configuration, the producer can easily input and register the information regarding the commodity via a commodity information registration screen displayed on the producer terminal. The information regarding the commodity including the commodity information input by the producer and the analysis information regarding the growth environment of the commodity performed in the analyzing facility via the analyzing facility terminal can be suitably provided to the viewer including the consumer via the viewer terminal.

In a preferred mode of the present invention, a product information registration unit is further provided, in which a factory terminal is a terminal operated in a processing factory that processes a commodity produced by a producer to produce a product, the product information registration unit accepts product information transmitted from the factory terminal and stores the product information in association with the commodity information of a commodity to be a raw material, and the provision unit provides the commodity information and further the product information associated with the commodity information to the viewer terminal.

With such a configuration, even in a case where the commodity is processed and provided as the product to the consumer, the product information is easily registered in association with the commodity information via the factory terminal in the processing factory, and the product information regarding the product and the commodity information and the analysis information of the commodity, which is the raw material of the product, are suitably provided to the viewer.

In a preferred mode of the present invention, the analysis result regarding a growth environment of a commodity included in the analysis information includes an analysis result of soil, and the analysis information further includes an analysis result regarding a component of a commodity.

With such a configuration, the analysis information including the analysis result of the component of the commodity analyzed in the analyzing facility and the analysis result regarding the growth environment including the analysis result of the soil can be suitably provided to the viewer.

In a preferred mode of the present invention, a request unit is further provided, in which the request unit accepts analysis request information regarding an analysis request of a commodity performed in an analyzing facility transmitted from the producer terminal, and stores the analysis request information in association with the commodity information, and the analysis information registration unit accepts and stores the analysis information including the analysis result of a commodity performed on the basis of the analysis request information from an analyzing facility terminal operated in the analyzing facility.

With such a configuration, it is possible to check the analysis request information regarding the analysis request transmitted by the producer to the analyzing facility.

In a preferred mode of the present invention, the production information registration unit accepts a growth record regarding a growth process of a commodity transmitted from the producer terminal and stores the growth record in association with the commodity information, and the provision unit provides the commodity information and the growth record associated with the commodity information to the viewer terminal.

With such a configuration, the producer can easily register the growth record of the commodity via the producer terminal and suitably provide the growth record to the viewer.

In a preferred mode of the present invention, a storage unit and a hash generation unit are further included, in which the production information registration unit is capable of updating the commodity information and/or the growth record stored in the storage unit by accepting an update request transmitted from the producer terminal, and the hash generation unit generates hash information from the analysis information including an analysis result of a commodity and stores the hash information in a block chain.

With such a configuration, since the commodity information and the growth record are written in the database, it is possible to update as necessary, for example, by rewriting or adding at a later date. In contrast, since the hash information generated from the analysis information including the analysis result of the commodity is stored in the block chain, this cannot be rewritten once written, and it is possible to prevent a decrease in reliability of the information due to falsification. Therefore, the updated new information and the information having the reliability that is not changed can be suitably provided to the viewer.

In a preferred mode of the present invention, a token generation unit is further included, in which when the analysis information is accepted, the token generation unit generates a token corresponding to the analysis information and stores the token in the block chain in association with the hash information.

With such a configuration, a unique token can be generated.

In a preferred mode of the present invention, the viewer terminal reads information provision request information attached as a label to a commodity or a product, and transmits the information provision request, and the provision unit provides the commodity information and the analysis information associated with the hash information stored in the block chain.

With such a configuration, when purchasing a commodity or a product, the viewer can easily acquire information regarding the commodity and/or the product by reading the label attached to the commodity or the product via the viewer terminal.

The present invention is an information providing method, by which a computer executes a production information registration step, an analysis information registration step, and a provision step, in which the production information registration step accepts and stores commodity information input via a commodity information registration screen in a producer terminal operated by a producer who produces a commodity, the analysis information registration step accepts analysis information and stores the analysis information in association with the commodity information, the analysis information is information regarding analysis of a commodity and includes an analysis result regarding a growth environment of a commodity, and the provision step accepts an information provision request transmitted from a viewer terminal operated by a viewer, and provides the commodity information and the analysis information to the viewer terminal.

The present invention is an information providing program that causes a computer to function as a production information registration unit, an analysis information registration unit, and a provision unit, in which the production information registration unit accepts and stores commodity information input via a commodity information registration screen in a producer terminal operated by a producer who produces a commodity, the analysis information registration unit accepts analysis information and stores the analysis information in association with the commodity information, the analysis information is information regarding analysis of a commodity and includes an analysis result regarding a growth environment of a commodity, and the provision unit accepts an information provision request transmitted from a viewer terminal operated by a viewer, and provides the commodity information and the analysis information to the viewer terminal.

### Advantageous Effects of Invention

According to the present invention, it is possible to provide an information providing system, an information providing method, and an information providing program for providing information regarding a commodity such as an agricultural product.

### BRIEF DESCRIPTION OF DRAWINGS

FIG. 1 is a block diagram of an information providing system in the present embodiment.

FIG. 2 is a hardware configuration diagram of each device in the present embodiment.

FIG. 3 is a block diagram of a functional configuration in the present embodiment.

FIG. 4 illustrates an example of a data configuration in the present embodiment.

FIG. 5 illustrates an example of a data configuration in the present embodiment.

FIG. 6 illustrates a screen display example in the present embodiment.

FIG. 7 illustrates a screen display example in the present embodiment.

FIG. 8 illustrates a screen display example in the present embodiment.

FIG. 9 illustrates a flowchart regarding processing in the present embodiment.

FIG. 10 illustrates a flowchart regarding processing in the present embodiment.

### DESCRIPTION OF EMBODIMENTS

Hereinafter, an information providing system regarding an embodiment of the present invention will be described with reference to the drawings. Note that, an embodiment hereinafter described is an example of the present invention; the present invention is not limited to the following embodiment and various configurations may also be adopted.

In the present embodiment, a configuration, an operation and the like of the information providing system will be described, but an information providing method, an information providing program, a computer-readable recording medium that records the program and the like having a similar configuration can also exhibit similar actions and effects. A series of processing according to the present embodiment hereinafter described is provided as a computer-executable program, and can be provided via a non-transitory computer readable recording medium such as a CD-ROM and a flexible disk, and further a communication line.

In the present embodiment, a commodity is a produce produced by a producer, and may be an agricultural product, a livestock product, cultivated fish and the like. A product is a processed product manufactured by processing a commodity in a processing factory, and may be processed food, a beverage, a cosmetic, clothing and the like. In a case where a product is manufactured by processing a commodity, there may be a plurality of commodities serving as raw materials of the product. In the present specification, an example in which the commodity is an agricultural product and the product is processed food of the agricultural product will be described.

A producer is a person who produces a commodity. In the present embodiment, the producer is an agricultural worker, but may be a livestock farmer, a farming person and the like as long as the producer is a person who produces a commodity. An analyzing facility indicates a facility provided with analyzing equipment capable of performing analysis regarding a growth environment and components of the commodity produced by the producer, and is a research institution such as a university in the present embodiment. The analyzing facility may be a component analyzing center, an agricultural cooperative, a certification organization and the like as long as the facility includes equipment capable of analyzing components. The analyzing equipment provided in the analyzing facility includes an analyzing instrument capable of analyzing components of a commodity including an amino acid analyzer and a sugar content meter. The processing factory indicates a factory that orders a commodity and processes a delivered commodity to manufacture a product. A viewer includes a consumer who requests provision of information including commodity information and views the provided information via a viewer terminal. The viewer may include another producer, and another producer who produces a commodity different from the commodity for which the information is requested may request information provision as the viewer and view the provided information.

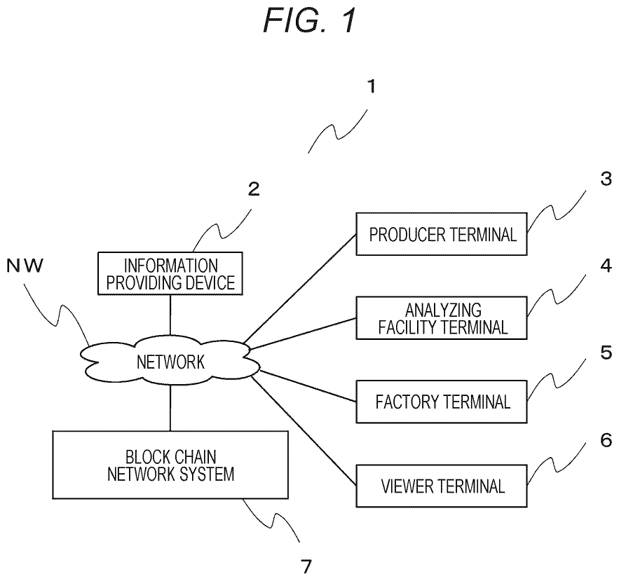

FIG. 1 is a configuration diagram of an information providing system 1 according to the present embodiment. As illustrated in FIG. 1, the information providing system 1 includes an information providing device 2, a producer terminal 3 operated by a producer, an analyzing facility terminal 4 operated in an analyzing facility, a factory terminal 5 operated in a processing factory, a viewer terminal 6 operated by a viewer, and a block chain network system 7. Although only one producer terminal 3, one analyzing facility terminal 4, one factory terminal 5, and one viewer terminal 6 are illustrated in FIG. 1, each terminal may be plural. The block chain network system 7 is a system including a plurality of nodes that stores a block chain on a network. The analyzing facility terminal 4 operated in the analyzing facility may be an instrument used as an analyzing device as long as the instrument is connected to a network NW, and may transmit an analysis result of a commodity analyzed as an analyzing device to the information providing device 2.

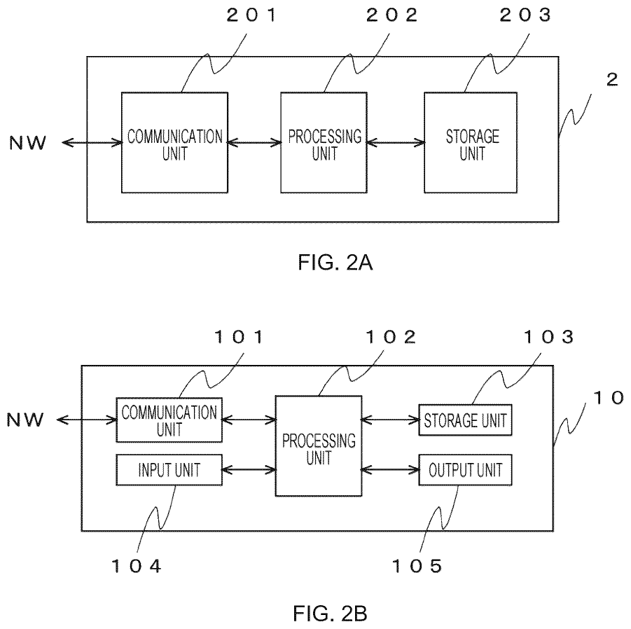

FIG. 2(a) is a hardware configuration diagram of the information providing device 2. The information providing device 2 includes a communication unit 201 for communicating with an external device via the network NW, a processing unit 202 by an arithmetic unit such as a central processing unit (CPU), and a storage unit 203 by a hard disc drive (HDD), a read only memory (ROM), a random access memory (RAM) and the like. The communication unit 201 performs communication control with the network NW and performs processing necessary for performing data communication with various devices. The storage unit 203 stores an information providing program, data including commodity information and analysis information used when the processing unit 202 executes processing on the basis of the program and the like. When the information providing program is executed by the processing unit 202, a computer can serve as the information providing device 2 that implements a functional configuration to be described later. The information providing device 2 can be configured as a computer device such as a server device.

FIG. 2(b) is a diagram illustrating an example of a hardware configuration of a terminal 10 (producer terminal 3, analyzing facility terminal 4, factory terminal 5, and viewer terminal 6). The terminal 10 includes a communication unit 101, a processing unit 102, a storage unit 103, an input unit 104, and an output unit 105 as the hardware configuration. The communication unit 101 controls communication with the network NW. The processing unit 102 includes an arithmetic unit such as a CPU and controls processing of the terminal 10. The storage unit 103 includes a HDD, a RAM, a ROM and the like, and stores an application and the like for cooperating with the information providing device 2 and/or the block chain network system 7. The input unit 104 is a touch panel, a mouse, a keyboard and the like, and inputs an operation request by a user to the processing unit 102. The output unit 105 is a display and the like, and outputs a processing result and the like of the processing unit 102. The terminal 10 is configured using a computer terminal such as a personal computer, a smartphone, and a tablet terminal.

The block chain used in the present invention is one mode of a distributed ledger, and may be a public chain, a private chain and the like.

The block chain is formed of a chain of data referred to as blocks. Since each block includes information regarding a hash value of a previous block, in a case where data of any block is falsified, inconsistency occurs in consistency of a chain of blocks. Therefore, falsification, deletion of a block and the like cannot be performed.

In the present embodiment, the information providing system 1 stores data in the storage unit 203 and the block chain of the block chain network system 7. The storage unit 203 includes a database DB that stores commodity information registered at the time of registration of a commodity, analysis information regarding analysis of the commodity, product information registered at the time of registration of a product, and a growth record regarding a growth process of the commodity. The block chain of the block chain network system 7 stores hash information generated from the analysis information and a token corresponding to the analysis information. In a case where there is an update request, the storage unit 203 can rewrite data stored in the storage unit 203 including the commodity information and the growth record according to the update request. In contrast, the hash information and the token stored in the block chain are included in the chain of blocks of the block chain, and when the change is made, inconsistency occurs in the chain of data of the blocks, so that they cannot be rewritten. Therefore, when the analysis information is falsified, the hash information stored in the block chain and the hash information generated again from the falsified analysis information do not match, so that it can be determined that the analysis information has been falsified.

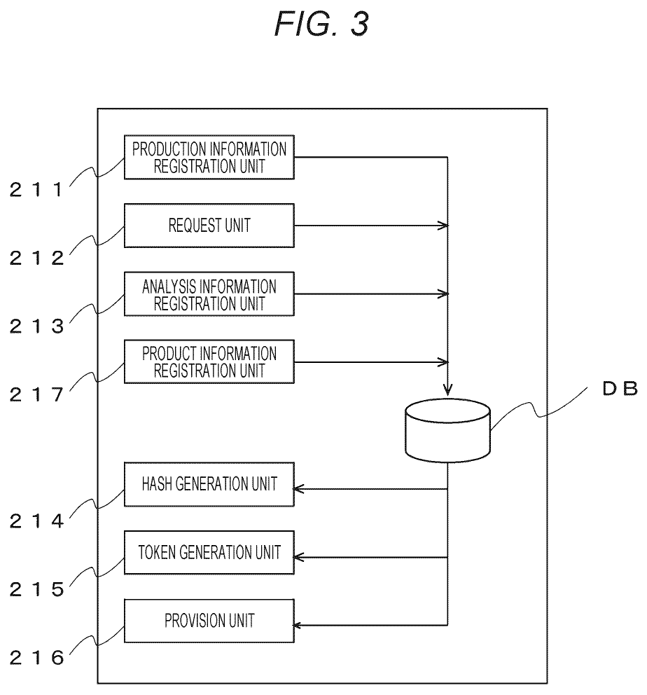

FIG. 3 is a block diagram of a functional configuration of the information providing device 2 of the information providing system 1 in the present embodiment.

The information providing device 2 includes a production information registration unit 211 that registers information from the producer terminal 3, a request unit 212 that accepts analysis request information, an analysis information registration unit 213 that registers the analysis information, a hash generation unit 214 that generates hash information from the analysis information, a token generation unit 215 that generates a token corresponding to the analysis information, a provision unit 216 that provides information, a product information registration unit 217 that registers product information, and a database DB.

Note that, when using the present system, the producer registers producer information regarding the producer in the database DB. The registered producer information includes a producer name and a contact address of the producer.

The production information registration unit 211 accepts registration of the commodity information via a commodity information registration screen in the producer terminal 3, and stores the same in the storage unit 203. The production information registration unit 211 accepts registration of the growth record via a growth record registration screen in the producer terminal 3, and stores the same in the storage unit 203.

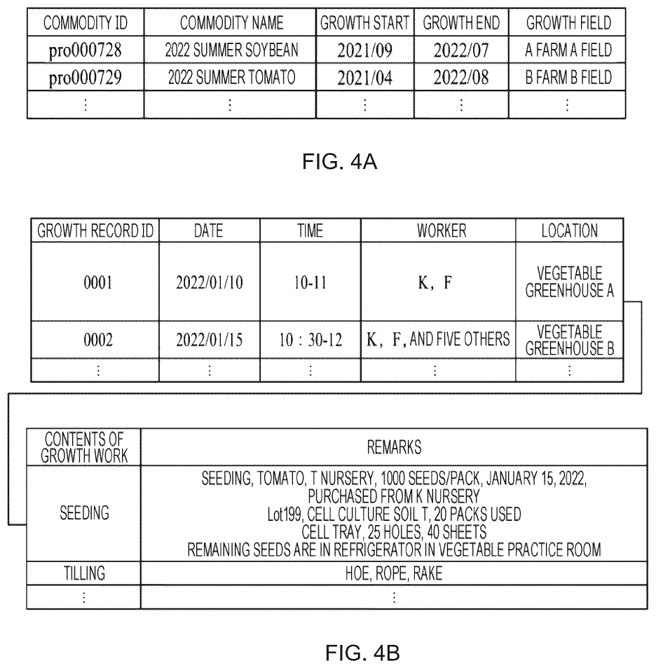

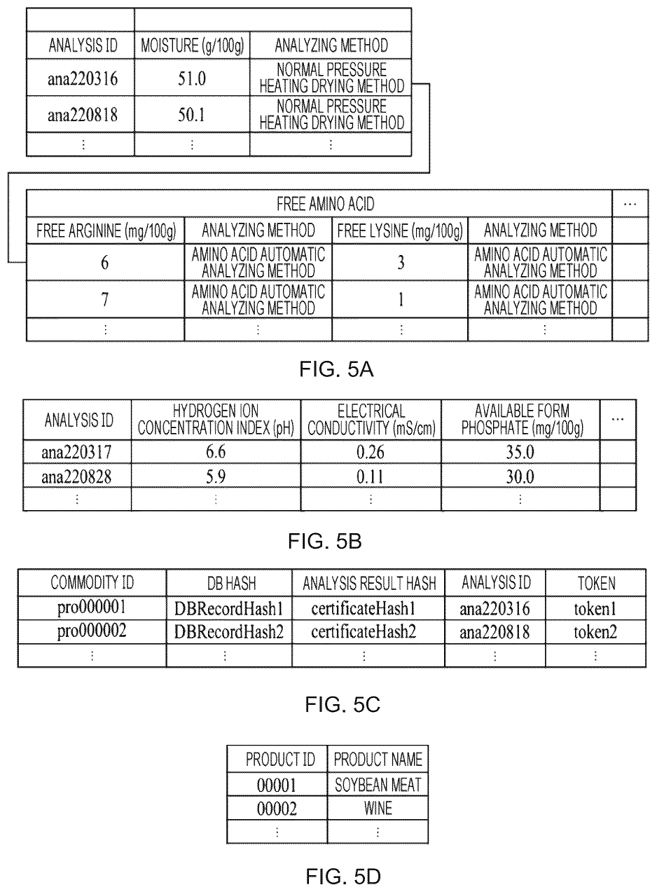

A data configuration in the present embodiment is illustrated in FIGS. 4 and 5. A data configuration illustrated in FIGS. 4 and 5 is an example of the data configuration in the present embodiment and is not limited to the present configuration.

The commodity information illustrated in FIG. 4(a) includes a commodity ID for identifying a commodity, a commodity name, a growth start period, a growth end period, and a growth field. The commodity information is registered in association with the producer information registered by the producer who produced the commodity. The commodity ID is information that can identify a commodity assigned when the commodity information is registered. The commodity information may include information regarding a production place and information that the producer wants to provide to the viewer regarding the commodity. The commodity information is registered via the commodity information registration screen displayed on the producer terminal 3.

The growth record illustrated in FIG. 4(b) is information regarding the growth process of a commodity, and includes the date and time when a growth work registered in the growth record is performed, a worker who performs the growth work regarding the growth of the commodity, and a growth record ID associated with information regarding a location of the field in which the commodity is produced and contents of the growth work, and the commodity ID. The growth record may further include information regarding a growth state of the commodity, an image of the commodity being grown and the like. The growth record is input via the growth record registration screen displayed on the producer terminal 3 and is registered in association with the commodity information. On the growth record registration screen, information regarding growth of a commodity displayed on the producer terminal 3 is registered. The growth record may include detailed work information corresponding to the contents of the growth work. The contents of the growth work include seeding, tilling, prevention, fertilization and the like. For example, when the content of the growth work is prevention, the detailed work information includes a type of applied pesticide (chemical pesticide, organic pesticide and the like). The growth record is input via the growth record registration screen in the producer terminal 3 and transmitted to the information providing device 2. The growth record is input every time the producer performs work regarding production of a commodity, and is stored in the storage unit 203 in association with the commodity information. In the present embodiment, the growth record is updated when a point to be corrected is found by the producer or the content is added at a later date to be stored, but the growth record of a final version fixed when the growth of the commodity is completed or at the time of shipping or the hash value generated from the growth record of the final version may be stored in the block chain.

The request unit 212 accepts the analysis request information regarding the analysis request of the commodity transmitted by the producer to the analyzing facility to store. The analysis request ID included in the analysis request information is registered in association with the commodity ID included in the commodity information. The analysis request information is information regarding the analysis request, and includes the date on which the analysis request is made, contents of the analysis request, information regarding the analyzing facility requested to perform analysis, and information regarding an analysis status indicating whether the requested analysis is completed or not. The analysis request information is stored in the storage unit 203 in association with the Commodity information. Regarding the analysis status included in the analysis request information, the analysis status is automatically completed when the analysis information is registered, but the analysis status included in the analysis request information may be input in the analyzing facility terminal 4.

The analysis information registration unit 213 accepts the analysis information regarding the analysis of the commodity transmitted from the analyzing facility terminal 4, and registers the same in association with the analysis request ID capable of specifying the analysis request included in the analysis request information. The analysis information registration unit 213 may accept the analysis information transmitted from the producer terminal 3 in a case where the producer operates the analyzing device to perform the component analysis. The analysis information registration unit 213 may store the analysis information not in the storage unit 203 but in the block chain. An ID for each growth field may be registered, and an analysis result regarding soil may be registered in association with the growth field ID for each field.

In the present embodiment, the analysis information registration unit 213 registers, in the storage unit 203, the analysis information including the analysis result of the component of the commodity illustrated in FIG. 5(a) and the analysis result regarding the growth environment of the commodity illustrated in FIG. 5(b). The analysis result of the component includes a component amount for each analysis item and an analyzing method for each analysis item. The analysis result regarding the growth environment includes a value for each analysis item and a method for each analysis item.

The analysis items of the analysis result of the component of the commodity illustrated in FIG. 5(a) are moisture and amino acid contained in the commodity, but may include other analysis items contained in the commodity, such as protein and energy amounts, sugar content, acidity, calorific value, and lipid, carbohydrate, cholesterol, inorganic matter, vitamin, and fatty acid contents. In an example illustrated in FIG. 5(a), the analysis result of the components of the commodity is obtained by a normal pressure heating drying method, an amino acid automatic analyzing method, and a high-speed liquid chromatography method, but a component analyzing method is not limited; for example, regarding the analysis of a moisture amount, the analysis may be performed by a method different from that in the example, such as the Karl Fischer method or a reduced pressure heating drying method.

The analysis result included in the analysis information includes the analysis result regarding the growth environment of the commodity including the analysis result of the soil illustrated in FIG. 5(b) and the analysis result regarding the component of the commodity illustrated in FIG. 5(a). In a case where the commodity is the agricultural product, the analysis result regarding the growth environment of the commodity may include the analysis result regarding the pesticide and water applied to the field at the time of production of the commodity, and may include the analysis result regarding the water and a culture medium used for cultivation of the commodity when the commodity is produced by hydroponic cultivation. In the present embodiment, the analysis result regarding the growth environment of the commodity is the analysis result regarding the environment in which the commodity has been grown, and may include the analysis result of feed in a case where the commodity is livestock products, and may include the analysis result of a water quality and feed in a case where the commodity is cultivated fish. In the example illustrated in FIG. 5(b), the analysis of the soil is performed on a hydrogen ion concentration index contained in the soil, an electrical conductivity, available form phosphate, and base saturation, but may be indirectly performed from the analysis result of the commodity including a relative growth rate, a net assimilation rate, a leaf area ratio, a nitrate ion concentration and the like.

The analysis information including these analysis results is stored in the analysis database included in the storage unit 203. A record of the analysis database includes an analysis ID of each of the analysis result of the component and the analysis result regarding the growth environment, and the analysis result.

The hash generation unit 214 generates the hash information from the analysis information and stores the same in the block chain. The hash information is a hash value obtained by encrypting data regarding the analysis information using a hash function, and includes, in the present embodiment, analysis result hash information generated from data of a value for each analysis item of the analysis result, and DB hash information generated from the record of the analysis database including the analysis ID, the data for each analysis item of the analysis result. Note that, the hash generation unit 214 may generate the DB hash information using the analysis result hash information.

The token generation unit 215 generates the token corresponding to the analysis information and stores the same in the block chain. The token generated corresponding to the analysis information may be used to check falsification in the analysis information similarly to the hash information.

The information providing device 2 transmits the commodity ID, the DB hash information, the analysis result hash information, and the analysis ID to the block chain network system 7 (node) to make a record request. The block chain network system 7 (node) that receives the record request stores the same in the block in association with the received information.

In the present embodiment, the block chain stores the DB hash information and the analysis result hash information, which are the hash information generated by the hash generation unit 214, the token generated by the token generation unit 215, the commodity ID of the commodity, and the analysis ID included in the analysis information corresponding to the hash information illustrated in FIG. 5(c).

When storing the hash information and the token in the block chain, the block chain network system 7 acquires the hash value of the previous block and stores the hash value in the block together with the hash information and the token to fix the block. In the present embodiment, the block chain network system 7 fixes the block in which the hash information and the token generated for each analysis are stored, but the hash information and the token regarding a plurality of analyses may be stored in one block and fixed. The hash value of the previous block is the hash value calculated from a block header stored in the previous block.

The provision unit 216 accepts an information provision request transmitted from the viewer terminal 6, and provides information regarding the commodity including the commodity information, the growth record, the analysis information, and the product information. In a case where the analysis takes time and the analysis information has not yet been registered when the information provision request is accepted, information regarding the same commodity produced in different periods, such as analysis information regarding a commodity produced in the same period last year or analysis information regarding a commodity produced in the same soil, may be provided to the viewer. Even in a case where there is an unregistered growth record such as a growth record regarding harvest when the information provision request is transmitted, such as when a commodity is purchased on a WEB site, the already registered growth record is provided to the viewer. When the information provision request is transmitted, such as after arrival of the commodity at the hand of the viewer, if a growth record, which has not been registered at the time of the previous information provision request, such as the growth record regarding harvest, is registered, information regarding the commodity including the newly registered growth record is provided to the viewer terminal 6. The provision unit 216 generates data for viewing to be displayed on the viewer terminal 6 on the basis of the commodity information, the growth record, the analysis information, and the product information. The provision unit 216 transmits the generated data for viewing to the viewer terminal 6. In the present embodiment, the data for viewing is generated before provision, but may be generated when there is the information provision request.

The product information registration unit 217 accepts the product information regarding the product transmitted from the factory terminal 5, and registers the same in association with the commodity ID included in the commodity information of the commodity that is the raw material. The product information is stored in the storage unit 203. The commodity information associated with the product information may be plural. The product information illustrated in FIG. 5(d) is information regarding the product, and includes a product ID and a product name, which are information for specifying the product. The product information may include information regarding the processing factory of the product, a component of the product, a commodity name or a commodity ID and the like of a raw material.

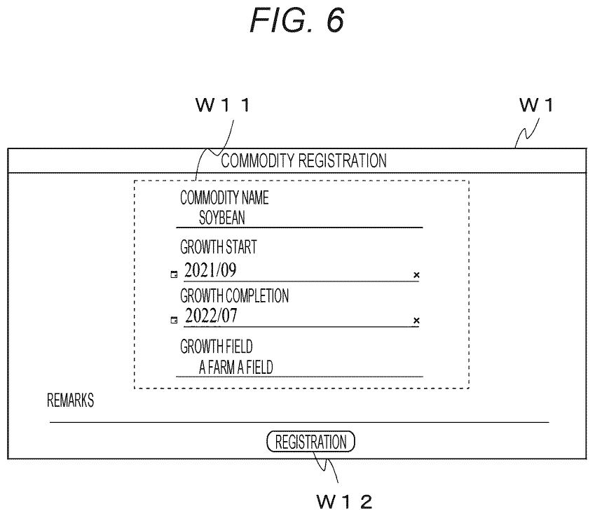

FIG. 6 illustrates a screen display example of the commodity information registration screen according to the present embodiment. A commodity registration screen W1 in FIG. 6 is a screen for registering the commodity information regarding the commodity produced by the producer, and is a screen displayed on the producer terminal 3. The commodity registration screen W1 includes a commodity information registration section W11 and a registration button W12. The commodity name, the growth start period, the growth end period, and the growth field can be input to the commodity information registration section W11. When the registration button W12 is pressed, the commodity information input to the commodity information registration section W11 is transmitted to the information providing device 2, and the production information registration unit 211 registers the received commodity information.

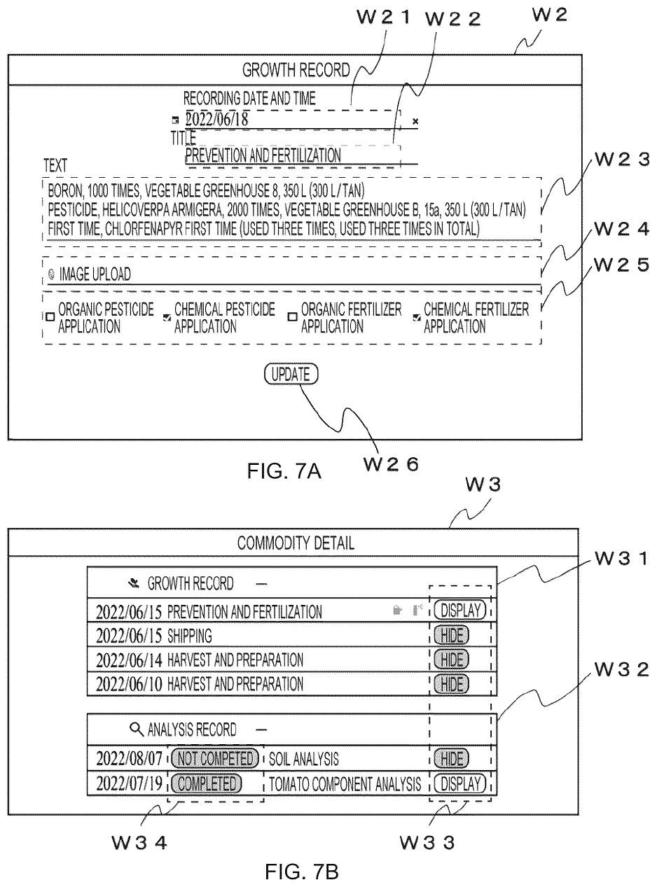

FIG. 7(a) is an example of screen display of the growth record registration screen for inputting a growth record. The growth record input screen W2 is a screen for inputting the growth record including information regarding the growth work performed by the producer in the growth process, and is displayed on the producer terminal 3. The growth record input screen W2 includes a recording date and time input section W21, a work content input section W22, and a work detail input section W23. The growth record input screen W2 further includes an image upload section W24 for uploading an image regarding the growth work or commodity. The growth detail selection section W25 illustrated in FIG. 7(a) accepts the detailed work information corresponding to the contents of the growth work selected in the work content input section W22. Since prevention and fertilization are selected as the contents of the growth work in the work content input section W22, the growth detail selection section W25 displays a pesticide/fertilizer selection section for selecting whether the pesticide used in the prevention work for producing the commodity is a chemical pesticide or an organic pesticide, or the fertilizer used in the fertilization work is a chemical fertilizer or an organic fertilizer, but when the contents of another growth work is selected, this displays the selection section for inputting the detailed work information corresponding to the contents of another growth work. When an update button W26 is pressed, the input growth record is transmitted from the producer terminal 3 to the information providing device 2, and the production information registration unit 211 registers the received growth record in association with the commodity information.

In the recording date and time input section W21, the date on which the growth work indicated in the growth record is performed can be input. In the work content input section W22, an outline of the growth work for growing the commodity performed by the producer. In the work detail input section W23, detailed information regarding the growth work such as information on the worker, the work time, tools used in the work, and the field in which the work is performed. In the image upload section W24, image data regarding the growth work or the commodity being grown may be uploaded, and stored as the growth record.

FIG. 7(b) illustrates a commodity detail screen W3 displaying the growth record, the analysis information, and the analysis request information. The commodity detail screen W3 is a screen on which information to be provided to the viewer terminal 6 can be selected regarding the growth record input on the growth record input screen W2 and the analysis information input via the analyzing facility terminal 4. The commodity detail screen W3 includes a growth record display section W31 that displays the growth record, an analysis record display section W32 that displays the analysis request information, a display/non-display selection section W33 that selects whether to provide the growth record and the analysis information to the viewer terminal 6, and an analysis status display section W34 that displays a current status of the analysis included in the analysis request information.

The growth record display section W31 displays the date on which the growth work included in the growth record is performed and the contents of the growth work performed by the producer. The analysis record display section W32 displays the analysis request information including the date on which the analysis request is made and information for specifying a commodity to be analyzed. The display/non-display selection section W33 can select whether to provide the growth record displayed on the growth record display section W31 and the analysis information of the analysis requested in the analysis request information displayed on the analysis record display section W32 to the viewer terminal 6. The analysis status display section W34 displays an analysis status such as whether the analysis is completed or not with respect to the analysis request made by the producer.

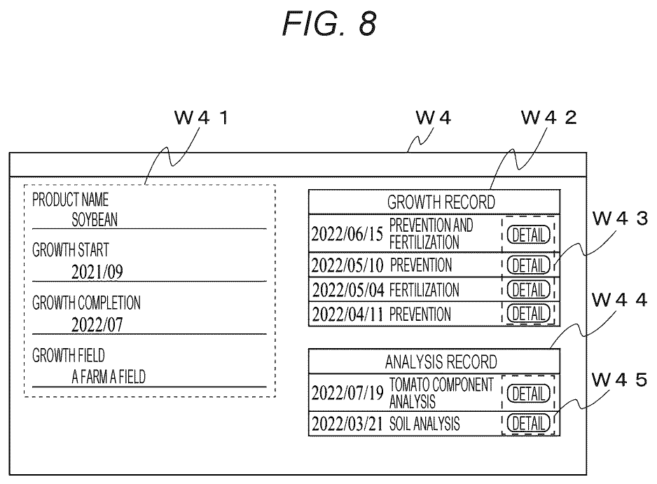

FIG. 8 illustrates a screen display example of an information provision screen W4 for providing information regarding the commodity including the commodity information and analysis information. In the present embodiment, the information provision screen W4 is displayed on the viewer terminal 6 by reading a label attached to the commodity and transmitting the information provision request, but may be displayed by transmitting the information provision request from a WEB site on which the commodity can be purchased.

The information provision screen W4 includes a commodity information presentation section W41, a growth record presentation section W42, a growth record detail display button W43, an analysis record presentation section W44, and an analysis information display button W45. The commodity information presentation section W41 displays the commodity information including the commodity name, the growth start, the growth end, and the growth field. The growth record presentation section W42 displays the content of the growth work included in the growth record and the date on which the growth work is performed. When being pressed, the growth record detail display button W43 moves to a growth record detail display page that displays detailed information of the growth work including remarks included in the growth record. The analysis record presentation section W44 displays the date on which the analysis request included in the analysis request information is made and the contents of the analysis request. When being pressed, the analysis information display button W45 moves to an analysis information display page that displays the analysis information including the analysis result of the component, and the analysis result regarding the growth environment of the commodity.

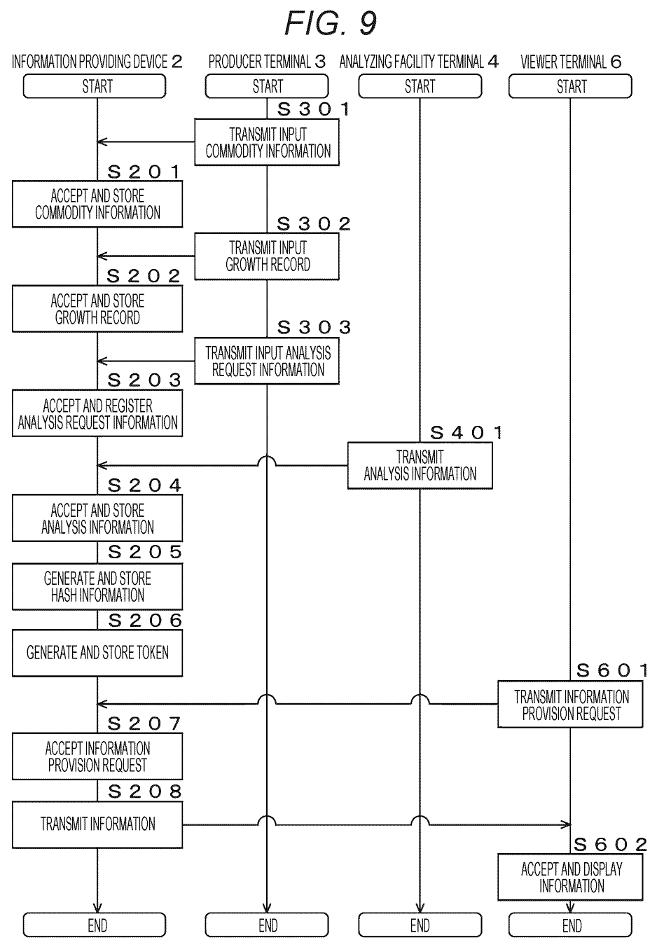

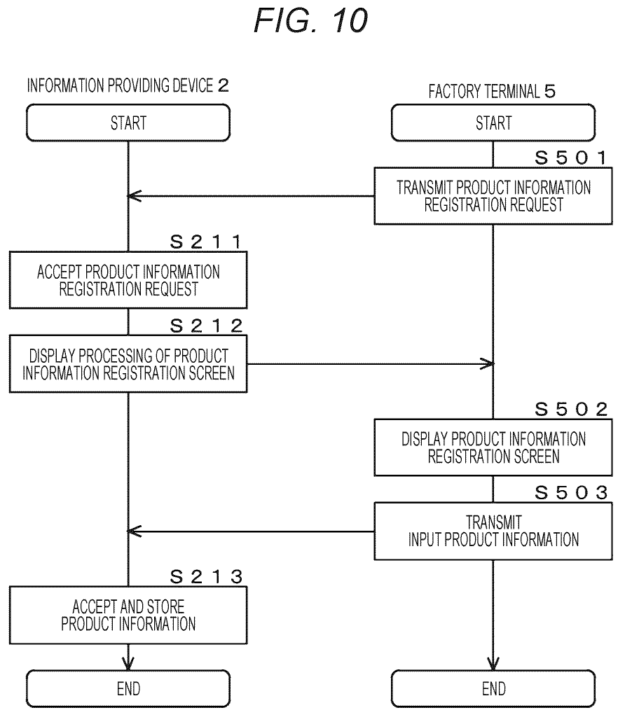

An example of a processing flow of the information providing system 1 in the present embodiment will be described with reference to FIGS. 9 and 10.

FIG. 9 is a flowchart of entire processing flow of the information providing device 2 regarding provision of information regarding the commodity including the commodity information, the growth record, the analysis information, and the product information. The producer terminal 3 transmits the commodity information input via the commodity information registration screen to the information providing device 2 (S301). The production information registration unit 211 accepts the commodity information and stores the same in the storage unit 203 (S201). The commodity ID capable of identifying the commodity assigned at the time of registration of the commodity information is registered as the commodity information together with the information input in the producer terminal 3. The producer terminal 3 transmits the growth record input via the growth record registration screen to the information providing device 2 (S302). The production information registration unit 211 accepts the growth record and stores the same in the storage unit 203 (S202). In the present embodiment, the growth record is input and transmitted via the producer terminal 3 each time the producer performs the work regarding the production of the commodity.

The producer transmits, to the analyzing facility, a produced commodity and/or a sample and the analysis request regarding the growth environment of the commodity including the soil of the field where the production is performed. At that time, an identifier and the like such as an ID that can specify the analysis request information is attached to the commodity or sample to be transmitted. The producer terminal 3 transmits the input analysis request information regarding the analysis request to the information providing device 2 (S303). The request unit 212 accepts the analysis request information, and stores the same in association with the commodity information of the commodity the analysis for which is requested (S203). The analysis request information is information regarding the analysis request of the commodity including the date and time when the analysis request is issued, information regarding contents of the analysis request, and information regarding the analysis status. The analysis request information may be transmitted from the analyzing facility terminal 4. The request unit 212 may transmit a notification to the analyzing facility terminal 4 when accepting the analysis request information. When the analyzing facility receives the analysis request, the commodity transmitted from the producer and/or the sample regarding the growth environment of the commodity is performed on the basis of the analysis request. The analyzing facility terminal 4 transmits the analysis information including the analysis result of the commodity to the information providing device 2 (S401). The analysis information registration unit 213 accepts the analysis information regarding the analysis performed in the analyzing facility, and stores the same in association with the analysis request information (S204). The analysis information may be registered in the analyzing facility terminal 4 via an analysis information registration screen for registering the analysis information.

When the analysis information is registered via the analysis information registration screen, the hash generation unit 214 generates the hash information from the analysis information and stores the same in the block chain (S205). In the present embodiment, the hash information includes the analysis result hash information generated from the analysis result of the commodity and the DB hash information generated from the record of the database of the analysis information. The hash information is stored in the block chain as the data regarding the analysis information, but the analysis information may be stored in the block chain. The token generation unit 215 generates the token corresponding to the analysis information and stores the same in the block chain (S206). The viewer terminal 6 reads the label attached to the commodity to transmit the information provision request regarding the commodity to the information providing device 2 (S601). The provision unit 216 accepts the information provision request (S207), and transmits the requested commodity information, the growth record, and the analysis information (S208). The viewer terminal 6 accepts and displays the information transmitted from the information providing device 2 (S602). In the present embodiment, the information provision request is transmitted by reading the label attached to the commodity via the viewer terminal 6, but when the viewer purchases the commodity on the Internet, the information provision request of the commodity information and the like of the commodity to be purchased may be transmitted so that the information regarding the commodity including the commodity information can be browsed. The information provision request information attached to the commodity or the product as the label is attached in the form of a QR code (registered trademark) in the present embodiment, and includes the commodity ID and information for transmitting the information provision request.

FIG. 10 is a flowchart of processing regarding product information registration. The factory terminal 5 stores order information in the storage unit DB by transmitting the commodity name of the commodity as the raw material of the product, the amount of the commodity, and an order destination (producer) to the information providing device 2. The producer terminal 3 refers to the order information and issues a label for delivery on the basis of the commodity ID of the commodity included in the order information. Note that, the factory terminal 5 only needs to be able to specify the commodity to be ordered on the producer side, and may be configured to transmit the order information to the producer terminal 3 by e-mail and the like. The label for delivery is attached to the commodity and delivered to the processing factory. The factory terminal 5 acquires the commodity information including the commodity ID by reading the label for delivery transmitted together with the commodity as the raw material of the product, and transmits a product information registration request (S501). The label for delivery is a label from which information including information for transmitting the product information registration request and the commodity information including the commodity ID of the delivered commodity can be read via the factory terminal 5. The information providing device 2 accepts the product information registration request from the factory terminal 5 (S211), and displays a product information registration screen (S212). The factory terminal 5 displays the displayed product information registration screen (S502), and transmits the product information input via the product information registration screen to the information providing device 2 (S503). The product information registration unit 217 accepts the product information transmitted from the factory terminal 5, and stores the same in association with the commodity information of the commodity as the raw material of the product (S213). When the product is related to a plurality of commodities, such as in a case where the product uses a plurality of commodities as raw materials, the commodity information associated with the product information may be plural. The registration of the product information in the factory terminal 5 is performed after the registration of the commodity information and the growth record of the commodity, which is the raw material of the product.

In the present embodiment, the commodity information and the growth record stored in the storage unit 203 can be rewritten, and the information providing device 2 rewrites and stores the information when accepting an update request from the producer terminal 3. The storage unit 203 may accept the update request from the factory terminal 5 and make the product information rewritable.

In the present embodiment, the information provision request by the viewer is transmitted by reading the label attached to the commodity or the product via the viewer terminal 6. The provision unit 216 accepts the information provision request and provides the requested information including the commodity information to the viewer terminal 6. The data provided to the viewer terminal 6 is data for viewing, and is generated from the commodity information, the growth record, the analysis information, and the product information. The data for viewing may be generated before the information provision or may be generated when the information provision request is accepted.

### REFERENCE SIGNS LIST

1 Information providing system
2 Information providing device
3 Producer terminal
4 Analyzing facility terminal
5 Factory terminal
6 Viewer terminal
7 Blockchain network system
203 Storage unit
211 Production information registration unit
212 Request unit
213 Analysis information registration unit
214 Hash generation unit
215 Token generation unit
216 Provision unit
217 Product information registration unit
DB Database

1. An information providing system for providing information regarding a commodity including a produce,
the information providing system comprising:
a production information registration unit; an analysis information registration unit; and a provision unit, wherein
the production information registration unit accepts and stores commodity information input via a commodity information registration screen in a producer terminal operated by a producer who produces a commodity,
the analysis information registration unit accepts analysis information and stores the analysis information in association with the commodity information,
the analysis information is information regarding analysis of a commodity and includes an analysis result regarding a growth environment of a commodity, and
the provision unit accepts an information provision request transmitted from a viewer terminal operated by a viewer, and provides the commodity information and the analysis information to the viewer terminal.

2. The information providing system according to claim 1, further comprising:
a product information registration unit, wherein
a factory terminal is a terminal operated in a processing factory that processes a commodity produced by a producer to produce a product,
the product information registration unit accepts product information transmitted from the factory terminal and stores the product information in association with the commodity information of a commodity to be a raw material, and
the provision unit provides the commodity information and further the product information associated with the commodity information to the viewer terminal.

3. The information providing system according to claim 1, wherein
the analysis result regarding a growth environment of a commodity included in the analysis information includes an analysis result of soil, and
the analysis information further includes an analysis result regarding a component of a commodity.

4. The information providing system according to claim 1, further comprising:
a request unit, wherein
the request unit accepts analysis request information regarding an analysis request of a commodity performed in an analyzing facility transmitted from the producer terminal, and stores the analysis request information in association with the commodity information, and
the analysis information registration unit accepts and stores the analysis information including the analysis result of a commodity performed on the basis of the analysis request information from an analyzing facility terminal operated in the analyzing facility.

5. The information providing system according to claim 1, wherein
the production information registration unit accepts a growth record regarding a growth process of a commodity transmitted from the producer terminal and stores the growth record in association with the commodity information, and
the provision unit provides the commodity information and the growth record associated with the commodity information to the viewer terminal.

6. The information providing system according to claim 5, further comprising:
a storage unit; and a hash generation unit, wherein
the production information registration unit is capable of updating the commodity information and/or the growth record stored in the storage unit by accepting an update request transmitted from the producer terminal, and
the hash generation unit generates hash information from the analysis information including an analysis result of a commodity and stores the hash information in a block chain.

7. The information providing system according to claim 6, further comprising:
a token generation unit, wherein
when the analysis information is accepted, the token generation unit generates a token corresponding to the analysis information and stores the token in the block chain in association with the hash information.

8. The information providing system according to claim 6, wherein
the viewer terminal reads information provision request information attached as a label to a commodity or a product manufactured by processing the commodity, and transmits the information provision request, and
the provision unit provides the commodity information and the analysis information associated with the hash information stored in the block chain.

9. An information providing method,
by which a computer executes a production information registration step, an analysis information registration step, and a provision step, wherein
the production information registration step accepts and stores commodity information input via a commodity information registration screen in a producer terminal operated by a producer who produces a commodity,
the analysis information registration step accepts analysis information and stores the analysis information in association with the commodity information,
the analysis information is information regarding analysis of a commodity performed in an analyzing facility and includes an analysis result regarding a growth environment of a commodity, and
the provision step accepts an information provision request transmitted from a viewer terminal operated by a viewer, and provides the commodity information and the analysis information to the viewer terminal.

10. An information providing program
that causes a computer to function as a production information registration unit, an analysis information registration unit, and a provision unit, wherein
the production information registration unit accepts and stores commodity information input via a commodity information registration screen in a producer terminal operated by a producer who produces a commodity,
the analysis information registration unit accepts analysis information and stores the analysis information in association with the commodity information,
the analysis information is information regarding analysis of a commodity performed in an analyzing facility and includes an analysis result regarding a growth environment of a commodity, and
the provision unit accepts an information provision request transmitted from a viewer terminal operated by a viewer, and provides the commodity information and the analysis information to the viewer terminal.
